(19) United States
(12) Patent Application Publication
(10) Pub. No.: US 2011/0304299 A1
(43) Pub. Date: Dec. 15, 2011

(54) SYSTEM OF CHARGING BATTERY PACK AND METHOD THEREOF

(75) Inventors: Jongwoon Yang, Yongin-si (KR); Segawa Susumu, Yongin-si (KR); Euijeong Hwang, Yongin-si (KR); Jinwan Kim, Yongin-si (KR); Hanseok Yun, Yongin-si (KR); Beomgyu Kim, Yongin-si (KR)

(73) Assignee: SAMSUNG SDI, CO., LTD., Yongin-si (KR)

(21) Appl. No.: 13/109,242

(22) Filed: May 17, 2011

(30) Foreign Application Priority Data
Jun. 9, 2010 (KR) 10-2010-0054487

(51) Int. Cl. H02J 7/04

(52) U.S. Cl. 320/107; 320/162

(57) ABSTRACT

A system and method of charging a battery pack in a state in which a battery management unit (BMU) is stably woken up. In one embodiment, the system of charging a battery pack includes a battery including at least one battery cell, a connector electrically connected to the battery and a battery management unit electrically connected to the battery and to the connector, the battery management unit to control charging and discharging operations of the battery, wherein the connector includes an auxiliary power supply terminal to provide a path of supplying auxiliary power to the battery management unit when a total voltage of the battery is less than a wake-up voltage of the battery management unit.

### CLAIM OF PRIORITY

This application makes reference to, incorporates into this specification the entire contents of, and claims all benefits accruing under 35 U.S.C. §119 from an application earlier filed in the Korean Intellectual Property Office filed on Jun. 9, 2010 and there duly assigned Serial No. 10-2010-0054487.

### BACKGROUND OF THE INVENTION

1. Field of the Invention

The present invention relates to a system of charging a battery pack and a method thereof.

2. Description of the Related Art

With the development of portable electrical/electronic devices, such as cellular phones, notebook computers, camcorders, personal digital assistants (PDAs) and the like, active research into secondary batteries is currently ongoing.

The secondary battery is used in a battery pack including a battery cell and a charge/discharge circuit, and charging or discharging of the battery cell is performed using an external power supply or an external load through external terminals provided in the battery pack. That is to say, when the external power supply is connected to the battery pack through the external terminals, the battery cell is charged using the external power supplied by the charge/discharge circuit. When the external load is connected to the battery pack through the external terminals, the battery cell is discharged in such a manner that power of the battery cell is supplied to the external load through the charge/discharge circuit and the external terminals. Here, the charge/discharge circuit is disposed between the external terminal and the battery cell and controls charging/discharging of the battery cell. The charge/discharge circuit is generally controlled by a battery management unit (BMU), which is operated using the power supplied from the battery cell.

However, when a voltage of the battery cell is smaller than a wake-up voltage of the BMU, driving and shut-down operations (the driving of the BMU is stopped) of the BMU may often be repeatedly performed, making it difficult to properly control the charging operation of the battery cell.

### SUMMARY OF THE INVENTION

It is therefore a feature of the present invention to provide a system and method of charging a battery pack in a state in which a battery management unit (BMU) is stably woken up.

According to one aspect of the present invention, there is provided a system of charging a battery pack including a battery including at least one battery cell, a connector electrically connected to the battery and a battery management unit electrically connected to the battery and to the connector, the battery management unit to control charging and discharging operations of the battery, wherein the connector includes an auxiliary power supply terminal to provide a path of supplying auxiliary power to the battery management unit when a total voltage of the battery is less than a wake-up voltage of the battery management unit.

The system may also include a DC-DC converter connected between the battery management unit and the auxiliary power supply terminal. The DC-DC converter may boost a voltage of the auxiliary power into a higher converted voltage, the higher converted voltage of the auxiliary power may be greater than or equal to the wake-up voltage. The connector may also include a first pack terminal connected to a first electrode terminal of the battery, a second pack terminal connected to a second electrode terminal of the battery and a plurality of communication terminals connected to the battery management unit. The system may also include a main power supply terminal connected between each of the first pack terminal, the battery management unit and the first electrode terminal of the battery. The system may also include a charging element connected between the first electrode terminal of the battery and the first pack terminal and a discharging element connected between the charging element and the first pack terminal.

The system may also include a selector connected between the battery management unit and the DC-DC converter, the selector to output the greater of a voltage level of charge power supplied from the first pack terminal and a voltage of converted auxiliary power supplied from the DC-DC converter, the selector including a first input terminal connected to the first pack terminal, a second input terminal connected to the DC-DC converter and an output terminal connected the battery management unit. The selector may also include a comparator having an input port connected to the first input terminal and the second input terminal, a first switch including a first control electrode connected to an output port of the comparator, a first electrode connected to the first input terminal, and a second electrode connected to an output terminal of the selector and a second switch including a second control electrode connected to the output port of the comparator, a third electrode connected to the second input terminal, and a fourth electrode connected to the output terminal of the selector.

The system may also include a selector connected between the battery management unit and the auxiliary power supply terminal, the selector to output a higher of a voltage of charge power supplied from the first pack terminal and a voltage of the auxiliary power supplied from the auxiliary power supply terminal, wherein the selector may also include a first input terminal connected to the first pack terminal, a second input terminal connected to the auxiliary power supply terminal and an output terminal connected to the battery management unit. The auxiliary power may be supplied from a charging device connected to the connector, the charging device may determine whether a total voltage of the battery is less than a wake-up voltage of the battery management unit. A voltage of the auxiliary power may be set by the charging device. A voltage of the auxiliary power may be greater than or equal to the wake-up voltage of the battery management unit. The system may also include a charging device connected to the connector, the charging of the battery may be in a preliminary charge mode when it is determined by the charging device a voltage of at least one of the at least one battery cells is less than a preliminary charge reference voltage.

According to another aspect of the present invention, there is provided a method of charging a battery pack including providing a battery including at least one battery cell, a connector electrically connected to the battery and including a first pack terminal, a second pack terminal and an auxiliary power supply terminal, and a battery management unit electrically connected to the battery and the connector, the battery management unit to control charging and discharging operations of the battery, the battery pack being connected to a charging device through the connector, the charging method including comparing a total voltage of the battery with a wake-up voltage of the battery management unit to determine whether the total voltage of the battery is less than the wake-up voltage of the battery management unit and supplying auxiliary power from the charging device to the battery management unit through the auxiliary power supply terminal of the connector when the total voltage of the battery is less than the wake-up voltage of the battery management unit.

The method may also include cutting off the supplying of auxiliary power when the total voltage of the battery is greater than or equal to the wake-up voltage of the battery management unit. The method may also include supplying normal charge power to the battery through the first pack terminal after the cutting off of the supplying of the auxiliary power. Before the comparing of the total voltage of the battery to the wake-up voltage, the method may also include comparing a preliminary charge reference voltage with a voltage of each of the at least one battery cells to determine whether a voltage of any of the at least one battery cells is less than the preliminary charge reference voltage and determining that the battery is in a preliminary charge mode when the voltage of any one of the at least one battery cells is less than the preliminary charge reference voltage.

The method may also include supplying preliminary charge power to the battery through the first pack terminal after the supplying of the auxiliary power to the battery management unit. In the supplying of the auxiliary power to the battery management unit, a higher voltage of a voltage of the charge power supplied from the first pack terminal and a voltage of the auxiliary power supplied from the auxiliary power supply terminal is supplied to the battery management unit. In the supplying of the auxiliary power to the battery management unit, a higher voltage of a voltage of the charge power supplied from the first pack terminal and a voltage of an auxiliary power supplied from the auxiliary power supply terminal and converted by a DC-DC converter is supplied to the battery management unit.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a circuit diagram of a charging system of a battery pack according to a first embodiment of the present invention;

FIG. 2 is a circuit diagram of a charging system of a battery pack according to a second embodiment of the present invention;

FIG. 3 is a detailed circuit diagram of a selector shown in FIG. 2; and

FIG. 4 is a flowchart illustrating a charging method of a battery pack according to an embodiment of the present invention.

### DETAILED DESCRIPTION OF THE INVENTION

Throughout the specification, when an element is described as being “coupled” to another element, the element may be “directly coupled” to the other element or “electrically coupled” to the other element through a third element or multiple other elements. In addition, unless explicitly described to the contrary, the word “comprise,” and variations such as “comprises” or “comprising,” will be understood to imply the inclusion of stated elements but not the exclusion of any other elements.

Reference will now be made in detail to the embodiments of the present invention, examples of which are illustrated in the accompanying drawings.

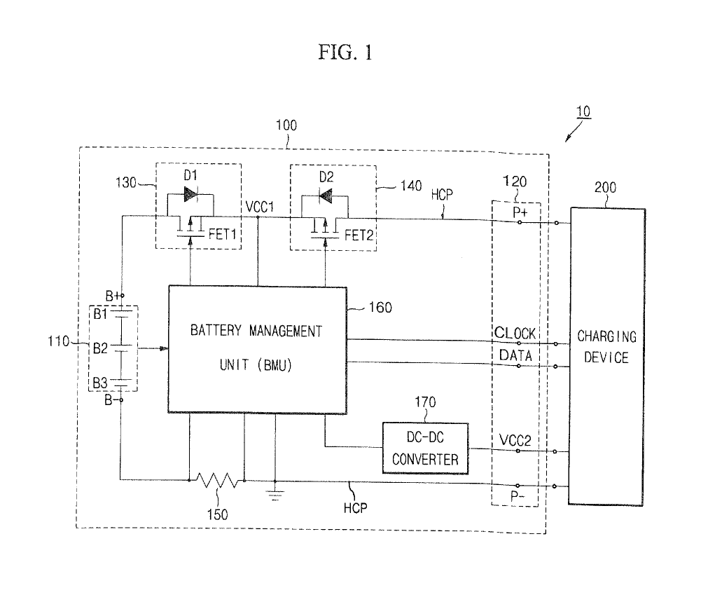

Turning now to FIG. 1, FIG. 1 is a circuit diagram of a charging system of a battery pack according to a first embodiment of the present invention. Referring to FIG. 1, the charging system 10 according to the first embodiment of the present invention includes a battery pack 100 and a charging device 200. The battery pack 100 may include a battery 110, a connector 120, charging element 130, discharging element 140, sensor resistor 150, a battery management unit (BMU) 160, and a DC-DC converter 170.

The aforementioned battery pack 100 is connected to the charging device 200 through the connector 120 and performs a charging operation of the battery 110. Although not shown, upon discharging operation, the battery pack 100 is instead connected to an external load, such as a cellular phone or a portable notebook computer, instead of the charging device 200. A high current path (HCP) between the connector 120 and the battery 110 is used as a charging/discharging path, and relatively high current flows through the HCP.

The charging device 200 may be any device as long as it supplies power required to charge the battery 110 of the battery pack 100. For example, a power supplying adapter itself or a portable notebook computer connected to the adapter may be used as the charging device 200. A configuration of the battery pack 100, specifically the charging system 10 of the battery pack 100, according to the embodiment of the present invention will now be described.

The battery 110 may include one or more battery cells B1, B2 and B3, and may be charged or discharged to a predetermined voltage. In the drawing, symbols B+ and B− denote high current terminals, that is, a first electrode terminal (positive electrode terminal) and a second electrode terminal (negative electrode terminal) of each of the battery cells B1, B2 and B3 connected to each other in series. Here, the battery 110 includes three battery cells B1, B2, and B3 connected to each other in series, however the number of battery cells connected to each other may vary according to the capacity required by the external load.

The connector 120 is connected to the battery 110, and operates as a terminal for the charging and discharging operations of the battery 110 when it is connected to the charging device 200 or an external load respectively. To this end, the connector 120 has a first pack terminal P+ and a second pack terminal P−. The first pack terminal P+ may be a positive pack terminal connected to a first electrode terminal B+ of battery 110, and the second pack terminal P− may be a negative pack terminal connected to a second electrode terminal B− of the battery 110. When the charging device 200 is connected to the connector 120, charging from the charging device 200 to the battery 110 is performed. When an external load is connected to the connector 120, discharging from the battery 110 to the external load is performed. Meanwhile, a main power supply terminal VCC1 is connected between each of the first pack terminal P+, the BMU 160 and the first electrode terminal B+ of the battery 110. The main power supply terminal VCC1 provides a path of supplying power from the battery 110 to the BMU 160, or a path of supplying power charged in the charging device 200 when the charging device 200 is connected to the battery pack 100 through the connector 120.

In addition, the connector 120 may include communication terminals connected to the BMU 160, specifically a clock terminal CLOCK, and a data terminal DATA. The communication terminals CLOCK and DATA allow communication between the BMU 160 and the charging device 200 when the charging device 200 is connected to the connector 120. The communication terminals CLOCK and DATA may transfer, for example, voltage information of the battery 110 from the BMU 160 to the charging device 200.

Further, the connector 120 includes an auxiliary power supply terminal VCC2 connected to the BMU 160. When the total voltage of the battery 110 is less than a wake-up voltage of the BMU 160, the auxiliary power supply terminal VCC2 provides a path of supplying auxiliary power from the charging device 200 to the BMU 160. The wake-up voltage of the BMU 160 is a voltage required for driving the BMU 160. Here, when the total voltage of the battery 110 is less than a wake-up voltage of the BMU 160, the minimum power needed by the BMU 160 to maintain at a wake-up state cannot be supplied by the battery 110. Under such a condition where the battery 110 has a low voltage, the BMU 160 instantaneously woken up by the charge power of the charging device 200 is repeatedly driven and shut down by the battery 110, thereby preventing the battery 110 from being charged smoothly. The occurrence of repeatedly performing of the driving and shutting-down operations of the BMU 160 often occurs when the battery 110 is preliminary charged to a relatively low power level using the charging device 200 and where a voltage of any one of the battery cells B1, B2 and B3 is less than a preliminary charge reference voltage. Thus, in order for the BMU 160 to be maintained at a stable wake-up state, the BMU 160 requires a separate power supply other than the power supplied from the battery 110. Here, the voltage of auxiliary power may be a voltage of the power supply set at the charging device 200, for example, 5 V, and the wake-up voltage of the BMU 160 may be greater than or equal to the voltage of auxiliary power, for example, 5 to 10 V. The auxiliary power may be supplied to the BMU 160 at its original voltage, or may be supplied after being boosted to a higher voltage, thereby allowing the BMU 160 to be maintained at a stable wake-up state.

Meanwhile, the determining of whether the total voltage of the battery 110 is less than the wake-up voltage of the BMU 160 and the determining of whether a voltage of any one of the battery cells B1, B2 and B3 is less than the preliminary charge reference voltage may be performed by the charging device 200. To this end, the charging device 200 receives voltage information of the battery 110 from the BMU 160 through the communication terminals CLOCK and DATA of the connector 120, stores voltages of the respective battery cells B1, B2 and B3 based on the voltage information of the battery 110, and calculates the total voltage of the battery 110.

The charging element 130 and the discharging element 140 are connected on the HCP between the battery 110 and the connector 120 and perform charging and discharging operations of the battery 110, respectively. Specifically, the charging element 130 is connected between the first electrode terminal B+ of the battery 110 and the first pack terminal P+ of the connector 120, while the discharging element 140 is connected between the charging element 130 and the first pack terminal P+ of the connector 120.

Each of the charging element 130 and the discharging element 140 includes a field effect transistor (FET) and a parasitic diode (D). Specifically, the charging element 130 includes FET1 and D1, and the discharging element 140 includes FET2 and D2. A source and a drain in the FET1 of the charging element 130 are connected in a direction opposite to those of the FET2 of the discharging element 140. With this configuration, the FET1 of the charging element 130 is configured to limit the current flow from the connector 120 to the battery 110, while the FET2 of the discharging element 140 is configured to limit the current flow from the battery 110 to the connector 120. Here, the FET1 and the FET2 of the charging and discharging elements 130 and 140 respectively may be switching elements, but aspects of the present invention are not limited thereto. Other types of electrical devices may also be used as long as they are capable of performing a switching operation. The parasitic diodes D1 and D2 of charging and discharging elements 130 and 140 respectively are configured to allow a current to flow in a direction opposite to the current limited direction.

The sensor resistor 150 is provided on the HCP between battery 110 and connector 120. Specifically, the sensor resistor 150 is connected between the second electrode terminal B− of the battery 110 and the second pack terminal P− of the connector 120. Opposite ends of the sensor resistor 150 may also be connected to the BMU 160. Accordingly, the sensor resistor 150 allows the BMU 160 to check voltage values of its opposite ends and a resistance value of the sensor resistor 150 to identify charge/discharge currents. Therefore, the sensor resistor 150 serves to transfer information regarding the charge current or the discharge current of the battery 110 to the BMU 160.

The BMU 160 is connected to the charging element 130, the discharging element 140, the battery 110 and the connector 120. The BMU 160 may be implemented as an integrated circuit (IC). The BMU 160 detects a voltage of the battery 110 from the battery 110, and controls operations of the charging element 130 and discharging element 140 based on the detected voltage. For example, when the charging device 200 is connected to the battery pack 100 through the connector 120, the BMU 160 sets the FET1 of the charging element 130 and the FET2 of the discharging element 140 to an ‘on’ state, thereby allowing the battery 110 to be charged. Likewise, when an external load is connected to the battery pack 100 through the connector 120, the BMU 160 sets the FET1 of the charging element 130 and the FET2 of the discharging element 140 to an ‘on’ state, thereby allowing the battery 110 to be discharged. Although not shown, the BMU 160 may also detect voltages of the respective individual battery cells B1, B2, and B3.

In addition, the BMU 160 stores the detected voltage of the battery 110, compares the same with preset voltage levels and turns on or off the charging element 130 and the discharging element 140 accordingly. For example, if the voltage of the battery 110 is greater than or equal to a preset overcharge level voltage value, the BMU 160 determines the battery 110 to be in an overcharged state and turns off the FET1 of the charging element 130. Then, charging from the charging device 200 to the battery 110 is interrupted. Here, the parasitic diode D1 of the charging element 130 allows the battery 110 to be discharged, even if the FET1 of the charging element 130 is turned off. Conversely, if the voltage of the battery 110 is less than a preset overdischarge level voltage value, the BMU 160 determines the battery 110 to be in an overdischarged state and turns off the FET2 of the discharging element 140. Then, discharging from the battery 110 to the external load is interrupted. Here, the parasitic diode D2 of the discharging element 140 allows the battery 110 to be charged even if the FET2 of the discharging element 140 is turned off.

In addition, the BMU 160 performs communication associated with the charging and discharging operations of the battery 110 with the charging device 200 through the communication terminals CLOCK and DATA. Specifically, the BMU 160 transfers voltage information of the battery 110 to the charging device 200. Accordingly, the BMU 160 allows the charging device 200 to identify the voltage information of the battery 110, thereby controlling the charging and discharging operations of the battery 110.

Further, when the charging device 200 determines that the total voltage of the battery 110 is less than the wake-up voltage of the BMU 160, the BMU 160 is supplied with auxiliary power from the charging device 200 through the auxiliary power supply terminal VCC2. Accordingly, the charging device 200 may allow the BMU 160 to be maintained at a stable wake-up state by providing auxiliary power to avoid the repeated driving and shutting-down operations of the BMU 160 that would otherwise occur when BMU 160 is being driven by battery 110 when battery 110 is in a depleted state.

The DC-DC converter 170 is connected between the BMU 160 and the auxiliary power supply terminal VCC2. The DC-DC converter 170 converts (i.e., steps up or boosts) the auxiliary power voltage supplied from the auxiliary power supply terminal VCC2 into a higher level voltage and supplies the same to the BMU 160. For example, the DC-DC converter 170 may step up the auxiliary power voltage of 5 V to higher level voltage of 10 V. Here, the auxiliary power voltage is converted into the higher level voltage for the purpose of supplying a sufficiently high enough voltage to wake up the BMU 160. In the scenario that the auxiliary power voltage is sufficiently high enough to wake-up the BMU 160, the DC-DC converter 170 may be omitted.

As described above, the charging system 10 of the battery pack according to the first embodiment of the present invention includes the connector 120 including the auxiliary power supply terminal VCC2 connected to the BMU 160 to provide an auxiliary power supply path to BMU 160, thereby allowing the BMU 160 to be maintained at a stable wake-up state via the charging device 200 when battery 110 is unable to stably provide the minimum voltage needed to maintain BMU 160 in a stable wake-up state.

Therefore, in the charging system 10 of the battery pack according to the first embodiment of the present invention, when the total voltage of the battery 110 is less than the wake-up voltage of the BMU 160, the BMU 160 is prevented from being repeatedly driven and shut down by battery 110, thereby allowing the battery 110 to be charged smoothly due to a stable wake-up state of the BMU 160.

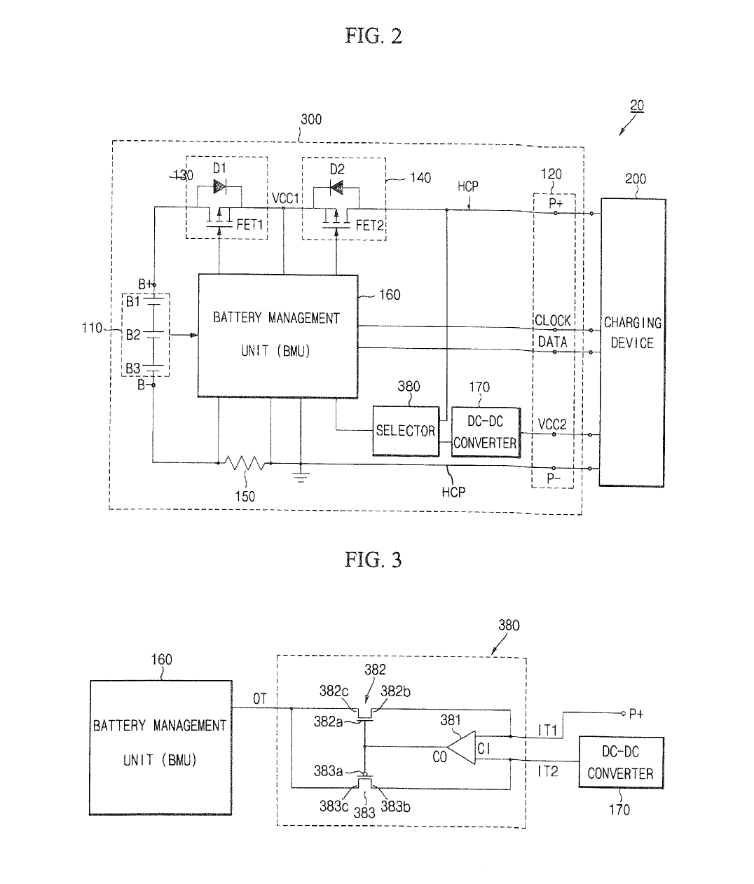

Turning now to FIGS. 2 and 3, FIG. 2 is a circuit diagram of charging system 20 of a battery pack according to a second embodiment of the present invention, and FIG. 3 is a detailed circuit diagram of selector 380 shown in FIG. 2. Charging system 20 of a battery pack according to the second embodiment of the present invention will now be described. The charging system 20 is substantially the same as the charging system 10 shown in FIG. 1 in terms of configuration and function, except that the battery pack 300 of the second embodiment further includes a selector 380. Thus, the charging system 20 will now be described with emphasis being given to the selector 380 of the battery pack 300, and repetitive descriptions will be omitted.

Referring to FIGS. 2 and 3, the charging system 20 essentially includes a battery pack 300 and a charging device 200. The battery pack 300 may include a battery 110, a connector 120, a charging element 130, a discharging element 140, a sensor resistor 150, a battery management unit (BMU) 160, a DC-DC converter 170, and a selector 380.

The selector 380 is connected between each of the BMU 160, the DC-DC converter 170 and a first pack terminal P+ of connector 120, and outputs a higher of a voltage of a charge power supplied from the first pack terminal P+ and a voltage of the converted auxiliary power supplied from the DC-DC converter 170. Accordingly, the selector 380 selects and supplies the higher level voltage to the BMU 160, thereby allowing the BMU 160 to be maintained at a stable wake-up state.

The selector 380 includes a first input terminal IT1 connected to the first pack terminal P+, a second input terminal IT2 connected to the DC-DC converter 170, and an output terminal OT connected the BMU 160. The selector 380 may further include a comparator 381, a first switch 382, and a second switch 383.

The comparator 381 has an input port CI connected to the first input terminal IT1 and the second input terminal IT2. In addition, the comparator 381 has an output port CO that outputs a ‘+’ voltage when the voltage of power supplied from the first pack terminal P+ is higher than the converted voltage of the auxiliary power supplied from the DC-DC converter 170, and outputs a ‘−’ voltage when the voltage of the converted auxiliary power is higher than the voltage of power supplied from the first pack terminal P+.

The first switch 382 includes a first control electrode 382a connected to the output port CO of the comparator 381, a first electrode 382b connected to the first input terminal IT1, and a second electrode 382c connected to the output terminal OT of the selector 380. When the output of the comparator 381 is a ‘+’ voltage, the first switch 382 is turned on to allow the charge power from the first pack terminal P+ of the connector 120 to be supplied to the BMU 160. The first switch 382 may be an N-channel metal-oxide-semiconductor-field-effect-transistor (MOSFET), but aspects of the present invention are not limited thereto.

The second switch 383 includes a second control electrode 383a connected to the output port CO of the comparator 381, a third electrode 383b connected to the second input terminal IT2, and a fourth electrode 383c connected to the output terminal OT of the selector 380. When the output of the comparator 381 is a ‘−’ voltage, the second switch 383 is turned on to allow the converted auxiliary power from the DC-DC converter 170 to be supplied to the BMU 160. The second switch 383 may be a P-channel MOSFET, but aspects of the present invention are not limited thereto.

While the selector 380 is connected between the BMU 160 and the DC-DC converter 170 in FIGS. 2 and 3, it may instead be connected between the BMU 160 and the auxiliary power supply terminal VCC2 of connector 120 in a case where the DC-DC converter 170 is not provided. In this modified scenario, selector 380 may output a higher of a voltage of the charge power supplied from the first pack terminal P+ and the voltage of the auxiliary power supplied from the auxiliary power supply terminal VCC2. In such a case, the second input terminal IT2 of the selector 380 is connected to the auxiliary power supply terminal VCC2.

As described above, the charging system 20 of the battery pack according to the second embodiment of the present invention includes the selector 380 connected between the BMU 160 and the charging device 200, thereby supplying a higher voltage of a power source to the BMU 160, and allowing the BMU 160 to be maintained at a more stable wake-up state.

Therefore, in the charging system 20 of the battery pack according to the second embodiment of the present invention, when the total voltage of the battery 110 is less than the wake-up voltage of the BMU 160, the BMU 160 is protected from being repeatedly driven and then shut down by the battery 110, thereby allowing the battery 110 to be charged smoothly via a more stable wake-up state of the BMU 160.

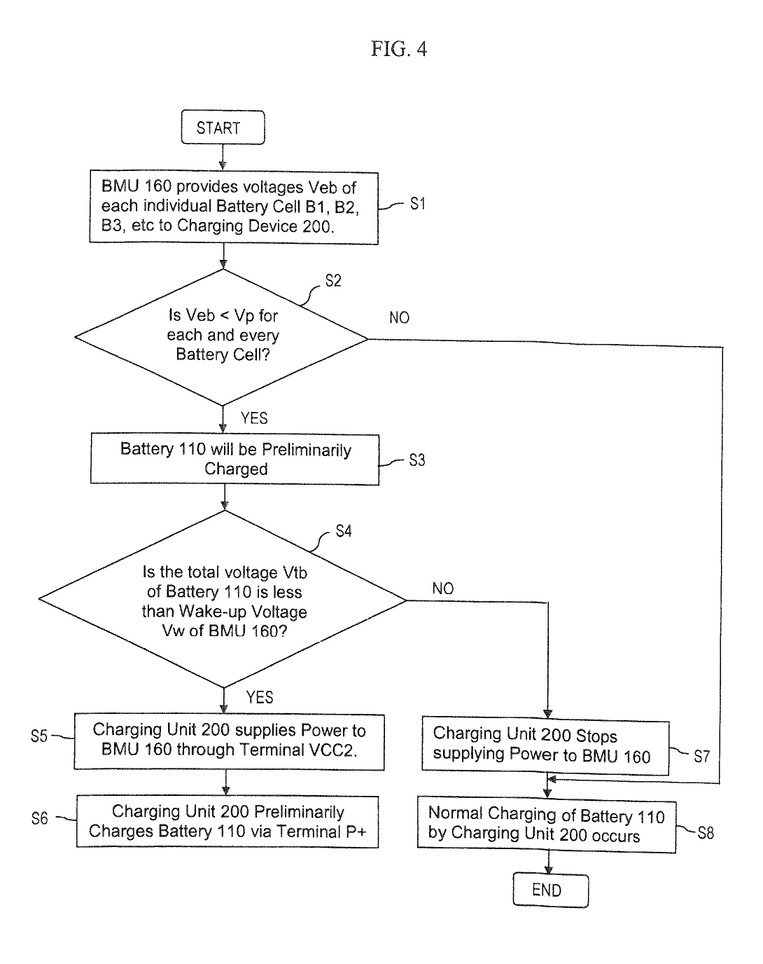

Turning now to FIG. 4, FIG. 4 is a view of a flow chart showing a method of charging a battery pack 100 according to an embodiment of the present invention. Referring to FIG. 4, the charging method of the battery pack 100 may include providing battery voltage information (S1), comparing the battery information to a preliminary charge reference voltage (S2), determining whether a preliminary charge mode is required (S3), comparing battery voltage to a wake-up voltage of BMU (S4), supplying auxiliary power to BMU (S5), supplying preliminary charge power to battery (S6), cutting off the supply of auxiliary power to BMU (S7), and supplying normal charge power to battery (S8). Here, assumptions are made that the battery pack 100 according to one embodiment is connected to the charging device 200, and at an early connection stage, the charge power of the charging device 200 is supplied to the BMU 160 through the main power supply terminal VCC1, thereby instantaneously waking up the BMU 160.

In step S1, the BMU 160 detects a voltage of the battery 110 and provides voltage information of the battery 110 to the charging device 200 through the communication terminals CLOCK and DATA. Here, the voltage information of the battery 110 may include a voltage Veb of each of the individual battery cells B1, B2, and B3 that make up battery 110.

In step S2, based on the voltage information of the battery 110, the charging device 200 compares the voltage Veb of each of the battery cells B1, B2, and B3 with a preliminary charge reference voltage Vp to determine whether or not the voltage Veb of any of the battery cells B1, B2, and B3 is less than the preliminary charge reference voltage Vp. Here, a fully charged voltage of each of the battery cells B1, B2, and B3 may be approximately 4.2 V, and the preliminary charge reference voltage Vp may be approximately 3 V, however, the preliminary charge reference voltage Vp may vary according to the fully charged voltage of each of the battery cells B1, B2, and B3.

In step S3, if it is confirmed that the voltage Veb of at least one of the battery cells B1, B2, and B3 is less than the preliminary charge reference voltage Vp, the charging device 200 determines that the battery 110 must first be charged in a preliminary charge mode where the battery 110 is charged at a lower power level than in a normal charge mode. The purpose of the preliminary charge mode is to prevent the battery 110 from deteriorating when high level power is supplied to the battery 110 having a low level of power.

In step S4, the charging device 200 compares the total voltage Vtb of the battery 110 with the wake-up voltage of the BMU 160 to determine whether the total voltage Vtb of the battery 110 is less than the wake-up voltage of the BMU 160 and to determine whether the BMU 160 should be powered by another power source other than battery 110 to prevent the BMU from continuously waking up and shutting off.

In step S5, if the total voltage Vtb of the battery 110 is less than the wake-up voltage of the BMU 160, the charging device 200 supplies auxiliary power to the BMU 160 through the auxiliary power supply terminal VCC2. Here, the auxiliary power may be boosted to a higher voltage by the DC-DC converter 170 before being supplied to the BMU 160. Alternately, the auxiliary power may be supplied directly to the BMU 160 without voltage boosting when the voltage of the auxiliary power is greater than or equal to the wake-up voltage of the BMU 160. Alternatively, the charging device 200 may instead supply a higher of the voltage of the charge power supplied from the first pack terminal P+ and the voltage of the converted auxiliary power supplied from the DC-DC converter 170 to the BMU 160 through the selector 380 shown in FIG. 2. Alternatively, when the DC-DC converter 170 is not provided, the charging device 200 may supply a higher of the voltage of the charge power supplied from the first pack terminal P+ and the voltage of the auxiliary power supplied from the auxiliary power supply terminal VCC2 to the BMU 160 through the selector 380.

In step S6, the charging device 200 supplies preliminary charge power to the battery 110 through the first pack terminal P+. Here, the supplying of the preliminary charge power may be continuously performed until the total voltage Vtb of the battery 110 becomes equal to the wake-up voltage of the BMU 160.

In step S7, when the total voltage Vtb of the battery 110 becomes greater than or equal to the wake-up voltage of the BMU 160, the charging device 200 stops supplying power to the BMU 160.

In step S8, when the supplying of the auxiliary power to the BMU 160 is halted, the charging device 200 supplies normal charge power to the battery 110 through the first pack terminal P+. Here, the normal charge power is a predetermined charge power depending on the voltage of the battery 110. Meanwhile, in step S2, if it is confirmed based on the voltage information of the battery 110 that the voltage Veb of each of the battery cells B1, B2, and B3 is greater than or equal to the preliminary charge reference voltage Vp, the charging device 200 determines that the charging of the battery 110 will occur in a normal charge mode as per step S8.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A system of charging a battery pack, comprising:
a battery including at least one battery cell;
a connector electrically connected to the battery; and
a battery management unit electrically connected to the battery and to the connector, the battery management unit to control charging and discharging operations of the battery,
wherein the connector includes an auxiliary power supply terminal to provide a path of supplying auxiliary power to the battery management unit when a total voltage of the battery is less than a wake-up voltage of the battery management unit.

2. The charging system of claim 1, further comprising a DC-DC converter connected between the battery management unit and the auxiliary power supply terminal.

3. The charging system of claim 2, the DC-DC converter to boost a voltage of the auxiliary power into a higher converted voltage, the higher converted voltage of the auxiliary power being greater than or equal to the wake-up voltage.

4. The charging system of claim 1, wherein the connector further comprises:
a first pack terminal connected to a first electrode terminal of the battery;
a second pack terminal connected to a second electrode terminal of the battery; and
a plurality of communication terminals connected to the battery management unit.

5. The charging system of claim 4, further comprising a main power supply terminal connected between each of the first pack terminal, the battery management unit and the first electrode terminal of the battery.

6. The charging system of claim 4, further comprising:
a charging element connected between the first electrode terminal of the battery and the first pack terminal; and
a discharging element connected between the charging element and the first pack terminal.

7. The charging system of claim 2, further comprising a selector connected between the battery management unit and the DC-DC converter, the selector to output the greater of a voltage level of charge power supplied from the first pack terminal and a voltage of converted auxiliary power supplied from the DC-DC converter, wherein the selector comprises:
a first input terminal connected to the first pack terminal;
a second input terminal connected to the DC-DC converter; and
an output terminal connected the battery management unit.

8. The charging system of claim 7, wherein the selector further comprises:
a comparator having an input port connected to the first input terminal and the second input terminal;
a first switch including a first control electrode connected to an output port of the comparator, a first electrode connected to the first input terminal, and a second electrode connected to an output terminal of the selector; and
a second switch including a second control electrode connected to the output port of the comparator, a third electrode connected to the second input terminal, and a fourth electrode connected to the output terminal of the selector.

9. The charging system of claim 1, further comprising a selector connected between the battery management unit and the auxiliary power supply terminal, the selector to output a higher of a voltage of charge power supplied from the first pack terminal and a voltage of the auxiliary power supplied from the auxiliary power supply terminal, wherein the selector further comprises:
a first input terminal connected to the first pack terminal;
a second input terminal connected to the auxiliary power supply terminal; and
an output terminal connected to the battery management unit.

10. The charging system of claim 1, wherein the auxiliary power is supplied from a charging device connected to the connector, the charging device to determine whether a total voltage of the battery is less than a wake-up voltage of the battery management unit.

11. The charging system of claim 10, wherein a voltage of the auxiliary power is set by the charging device.

12. The charging system of claim 10, wherein a voltage of the auxiliary power is greater than or equal to the wake-up voltage of the battery management unit.

13. The charging system of claim 1, further comprising a charging device connected to the connector, wherein the charging of the battery is in a preliminary charge mode when it is determined by the charging device a voltage of at least one of the at least one battery cells is less than a preliminary charge reference voltage.

14. A method of charging a battery pack, comprising:
providing a battery including at least one battery cell, a connector electrically connected to the battery and including a first pack terminal, a second pack terminal and an auxiliary power supply terminal, and a battery management unit electrically connected to the battery and the connector, the battery management unit to control charging and discharging operations of the battery, the battery pack being connected to a charging device through the connector, the charging method comprising:
comparing a total voltage of the battery with a wake-up voltage of the battery management unit to determine whether the total voltage of the battery is less than the wake-up voltage of the battery management unit; and
supplying auxiliary power from the charging device to the battery management unit through the auxiliary power supply terminal of the connector when the total voltage of the battery is less than the wake-up voltage of the battery management unit.

15. The charging method of claim 14, further comprising cutting off the supplying of auxiliary power when the total voltage of the battery is greater than or equal to the wake-up voltage of the battery management unit.

16. The charging method of claim 15, further comprising supplying normal charge power to the battery through the first pack terminal after the cutting off of the supplying of the auxiliary power.

17. The charging method of claim 14, wherein before the comparing of the total voltage of the battery to the wake-up voltage, further comprising:
comparing a preliminary charge reference voltage with a voltage of each of the at least one battery cells to determine whether a voltage of any of the at least one battery cells is less than the preliminary charge reference voltage; and
determining that the battery is in a preliminary charge mode when the voltage of any one of the at least one battery cells is less than the preliminary charge reference voltage.

18. The charging method of claim 17, further comprising supplying preliminary charge power to the battery through the first pack terminal after the supplying of the auxiliary power to the battery management unit.

19. The charging method of claim 14, wherein in the supplying of the auxiliary power to the battery management unit, the higher voltage of a voltage of the charge power supplied from the first pack terminal and a voltage of the auxiliary power supplied from the auxiliary power supply terminal is supplied to the battery management unit.

20. The charging method of claim 14, wherein in the supplying of the auxiliary power to the battery management unit, the higher voltage of a voltage of the charge power supplied from the first pack terminal and a voltage of an auxiliary power supplied from the auxiliary power supply terminal and converted by a DC-DC converter is supplied to the battery management unit.
